(19) United States
(12) Patent Application Publication
(10) Pub. No.: US 2025/0178270 A1
(43) Pub. Date: Jun. 5, 2025

(54) FILM FORMING APPARATUS, FILM FORMING METHOD, AND ARTICLE MANUFACTURING METHOD

(71) Applicant: CANON KABUSHIKI KAISHA, Tokyo (JP)

(72) Inventor: TOMOHIKO YOSHIDA, Tochigi (JP)

(21) Appl. No.: 18/956,288

(22) Filed: Nov. 22, 2024

(30) Foreign Application Priority Data
Dec. 1, 2023 (JP) 2023-204129

(51) Int. Cl. B29C 59/02; B29C 35/08; B29C 59/00

(52) U.S. Cl. CPC B29C 59/02; B29C 35/0805; B29C 59/002; B29K 2883/00

(57) ABSTRACT

A film forming apparatus includes a first station configured to execute a preparation process of preparing a structure with an uncured formable material sandwiched between a substrate and a mold, and a separation process of separating the mold from the formable material of the structure after the formable material is cured, one or a plurality of second stations configured to execute a curing process of forming a cured film by curing the formable material of the structure, and a conveyance mechanism configured to convey the structure between a plurality of stations including the first station and the second station.

### BACKGROUND OF THE INVENTION

### Field of the Invention

The present invention relates to a film forming apparatus, a film forming method, and an article manufacturing method.

### Description of the Related Art

A method of obtaining a cured film by arranging a formable material such as a curable composition on a substrate, bringing a mold into contact with the formable material, and curing the formable material by applying curing energy has been known. When a mold having a surface with a pattern formed therein is used, a cured film with the pattern transferred thereto can be obtained. Alternatively, when a mold having a flat surface is used, a cured film having a planarized surface can be obtained (Japanese Patent Laid-Open No. 2018-531786).

In the method as described above, after the mold contacts the formable material on the substrate, a certain amount of time is required until the formable material fills the space between the substrate and the mold. This can be a major factor that causes a decrease in throughput.

### SUMMARY OF THE INVENTION

The present invention provides a technique advantageous in improving the throughput of a film forming process.

One of aspect of the present invention provides a film forming apparatus comprising: a first station configured to execute a preparation process of preparing a structure with an uncured formable material sandwiched between a substrate and a mold, and a separation process of separating the mold from the formable material of the structure after the formable material is cured; one or a plurality of second stations configured to execute a curing process of forming a cured film by curing the formable material of the structure; and a conveyance mechanism configured to convey the structure between a plurality of stations including the first station and the second station.

Further features of the present invention will become apparent from the following description of exemplary embodiments with reference to the attached drawings.

### BRIEF DESCRIPTION OF THE DRAWINGS

FIG. 1 is a view schematically showing the arrangement of a film forming apparatus according to an embodiment;

FIGS. 2A to 2C are views showing the procedure of a film forming method of forming a cured film by the cured product of a formable material on a substrate;

FIG. 3 is a plan view for explaining conveyance of a superstrate, a substrate, and a structure;

FIG. 4 is a view showing the first embodiment of the operation of the film forming apparatus or the film forming method; and

FIG. 5 is a view showing the second embodiment of the operation of the film forming apparatus or the film forming method.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

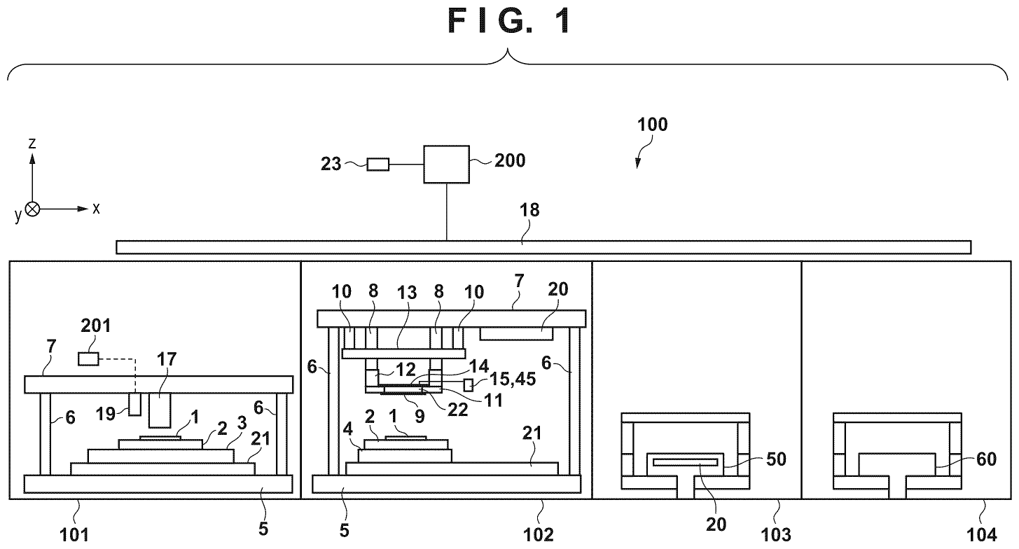

FIG. 1 schematically shows the arrangement of a film forming apparatus 100 according to an embodiment. The film forming apparatus 100 can be formed as an apparatus that forms the cured film of a formable material on a substrate by using a mold. The film forming apparatus 100 can be formed as a planarization apparatus that forms a planarized cured film by using a mold having a flat surface. Alternatively, the film forming apparatus 100 can be formed as an imprint apparatus that forms a patterned cured film on a substrate by using a mold having a surface with a pattern formed therein. A mold having a flat surface can also be called a superstrate. An example will be described below in which the film forming apparatus 100 is formed as a planarization apparatus.

The formable material is a curable composition (to be also referred to as a resin in an uncured state) to be cured by receiving curing energy. As the curing energy, heat, an electromagnetic wave, or the like can be used. Heat can be applied to the formable material via a heated member or by light irradiation. The electromagnetic wave can be, for example, light selected from the wavelength range of 10 nm (inclusive) to 1 mm (inclusive), such as infrared light, a visible light beam, or ultraviolet light. The curable composition can be a composition cured by heating or light irradiation. Among compositions, a photo-curable composition cured by light irradiation contains at least a polymerizable compound and a photopolymerization initiator, and may further contain a nonpolymerizable compound or a solvent, as needed. The nonpolymerizable compound is at least one material selected from the group consisting of a sensitizer, a hydrogen donor, an internal mold release agent, a surfactant, an antioxidant, and a polymer component. The formable material can be arranged on a substrate in the form of droplets or in the form of an island or film formed by connecting a plurality of droplets. Alternatively, the formable material may be supplied onto a substrate in the form of a film by a spin coater or a slit coater. The viscosity (the viscosity at 25° C.) of the formable material can be, for example, 1 mPa·s (inclusive) to 100 mPa·s (inclusive). The formable material can include, for example, a monomer such as acrylate or methacrylate.

The film forming apparatus 100 forms a cured film by applying a formable material on a substrate 1 and curing the formable material. The film forming apparatus 100 can include, for example, four stations 101, 102, 103, and 104 and a conveyance mechanism 18. Each of the stations 101, 102, 103, and 104 may be understood as a processing apparatus. The station 101 executes an application process of applying a curable composition on the substrate 1. The station 102 executes a preparation process of preparing a structure with the uncured formable material sandwiched between the substrate 1 and a superstrate 9, and a separation process of separating the superstrate 9 from the formable material of the structure after the formable material is cured. The station 103 executes a curing process of forming a cured film by curing the formable material of the structure. The curing process can include at least one of a heating process and a light irradiation process. The station 104 executes a cooling process of cooling the structure having undergone the curing process in the station 103. The station 101 and the station 102 can be combined into one station. The station 103 and the station 104 can be combined into one station.

The substrate 1 can include one or a plurality of layers on a plate-shaped base material. The substrate 1 that may not include such the layer can be a substrate including a silicon wafer as a base material, but the substrate 1 is not limited to this. The substrate 1 can include, as the base material, a substrate for a semiconductor device made of aluminum, a titanium-tungsten alloy, an aluminum-silicon alloy, an aluminum-copper-silicon alloy, silicon oxide, silicon nitride, or the like. Note that a substrate on which an adhesion layer has been formed by surface treatment such as silane coupling treatment, silazane treatment, film formation of an organic thin film, or the like to improve the adhesiveness to the formable material may be used as the substrate 1. Note that the substrate 1 has, for example, a circular shape with a diameter of 300 mm, but is not limited thereto.

The superstrate 9 can be made of, for example, glass or quartz. Alternatively, the superstrate 9 can be made of polymethyl methacrylate (PMMA) or a phototransparent resin such as a polycarbonate resin. Alternatively, the superstrate 9 can be made of silicon, a transparent metal vapor deposition film, a flexible film such as polydimethylsiloxane, a photo-curable film, or a metal film. The superstrate 9 preferably has a circular shape with a diameter larger than 300 mm and smaller than 500 mm, but is not limited thereto. The thickness of the superstrate 9 is preferably 0.25 mm or more and less than 2 mm, but is not limited thereto.

As exemplarily shown in FIG. 1, each of the stations 101 and 102 can include a substrate chuck 2, a stage driver 21, a base plate 5, pillars 6, and a top plate 7. The station 101 can further include a substrate stage 3 supporting the substrate chuck 2, an alignment scope 19, and a supplier 17. The station 102 can further include a substrate stage 4 supporting the substrate chuck 2, pillars 10, a head 12, an alignment rack 13, and a deformation mechanism 45.

The film forming apparatus 100 can include the conveyance mechanism 18 that conveys the superstrate 9 and the substrate 1, an interface 23, and a controller 200. The substrate chuck 2 and the substrate stage 3 constitute a movable body that moves while holding the substrate 1, and the substrate chuck 2 and the substrate stage 4 constitute a movable body that moves while holding the substrate 1. A mold chuck 11 and the head 12 constitute a superstrate driver that moves while holding the superstrate 9. In this case, an XYZ coordinate system is defined such that the horizontal plane is the XY plane, and the vertical direction is the Z-axis direction.

Each of the substrate stage 3 and the substrate stage 4 is supported by the corresponding base plate 5, and holds the corresponding substrate chuck 2. Each of the substrate stage 3 and the substrate stage 4 can be driven in the X-axis direction and the Y-axis direction to position the substrate 1 held by the substrate chuck 2 at a target position. Each stage driver 21 can include, for example, a linear motor or a ball screw type linear slide. Each stage driver 21 can drive the corresponding substrate stage 3 or 4 in at least the X-axis direction and the Y-axis direction. Each stage driver 21 may be configured to drive the corresponding substrate stage 3 or 4 in directions of six axis directions or more (for example, six axis directions). Each stage driver 21 can include a rotation mechanism and rotationally drive the substrate chuck 2 or the corresponding substrate stage 3 or 4 around an axis parallel to the Z-axis direction.

The superstrate 9 is loaded from outside the film forming apparatus 100 by the conveyance mechanism 18 including a conveyance hand or the like, and held by the mold chuck 11. The superstrate 9 has, for example, a circular or rectangular outer shape, and includes a flat portion that comes into contact with the formable material on the substrate 1 and conforms to the surface shape of the substrate 1. For example, the flat portion can have a size equal to or larger than that of the substrate 1. The mold chuck 11 is supported by the head 12, and has a function of correcting the tilt of the superstrate 9. The mold chuck 11 can hold the superstrate 9 by a mechanical holding mechanism. The head 12 can hold the mold chuck 11 by a mechanical holding mechanism.

The head 12 provided in the station 102 can include a driving mechanism for elevating the mold chuck 11, that is, moving the mold chuck 11 in the Z-axis direction (a direction parallel to the vertical direction) in the preparation process and the separation process. In the preparation process, the head 12 lowers the mold chuck 11 holding the superstrate 9 to bring the superstrate 9 into contact with the formable material on the substrate 1, thereby preparing a structure with the uncured formable material sandwiched between the substrate 1 and the superstrate 9. Then, the head 12 lifts the head 12 to separate the head 12 from the structure. In the separation process, the head 12 lowers the mold chuck 11 to bring the mold chuck 11 into contact with the superstrate 9 of the structure with the formable material cured in the curing step. In the separation process, the head 12 then causes the mold chuck 11 to hold the superstrate 9, and lifts the mold chuck 11 holding the superstrate 9. This separates the superstrate 9 from the cured formable material. The driving mechanism provided in the head 12 can include, for example, a linear motor, a ball screw type linear slide, or an actuator such as a voice coil motor.

A load cell for measuring the pressing force of the superstrate 9 against the formable material on the substrate 1 can be provided in the head 12 or the mold chuck 11. The deformation mechanism 45 for deforming the superstrate 9 may be provided in the station 102. The deformation mechanism 45 can include a sealing member 14 configured to form a closed space 22 on the back surface side of the superstrate 9, and a pressure adjuster 15 that adjusts the pressure of the closed space 22. The sealing member 14 can include, for example, a light transmissive flat plate member such as silica glass. When the pressure adjuster 15 increases the pressure of the closed space 22, the superstrate 9 can be deformed into a downward convex shape. Then, when the pressure adjuster 15 decreases the pressure of the closed space 22, the deformation amount of the superstrate 9 can be decreased.

In the station 102, the base plate 5 supports the pillars 6, and the pillars 6 support the top plate 7. Guide bars 8 are suspended on the top plate 7 and fixed to the head 12 through the alignment rack 13. The alignment rack 13 is suspended on the top plate 7 via the pillars 10.

In the station 101, the alignment scope 19 can detect the position of an alignment mark provided in the substrate 1 and the position of a reference mark provided in the substrate stage 3. The supplier (dispenser) 17 can discharge an uncured formable material onto the substrate 1 to apply the formable material onto the substrate 1. The supplier 17 includes, for example, a discharger of a piezoelectric jet method or a micro-solenoid method, and can supply droplets of the formable material each having a minute volume of about 1 pL (picoliter) onto the substrate 1. The supplier 17 can include one or a plurality of discharge orifices for discharging droplets of the formable material.

The controller 200 controls the operation of the film forming apparatus 100 by controlling the respective components of the film forming apparatus 100. The controller 200 can be formed from, for example, a PLD (an abbreviation of Programmable Logic Device) such as an FPGA (an abbreviation of Field Programmable Gate Array), an ASIC (an abbreviation of Application Specific Integrated Circuit), a general-purpose or dedicated computer installed with a program, or a combination of all or some of them.

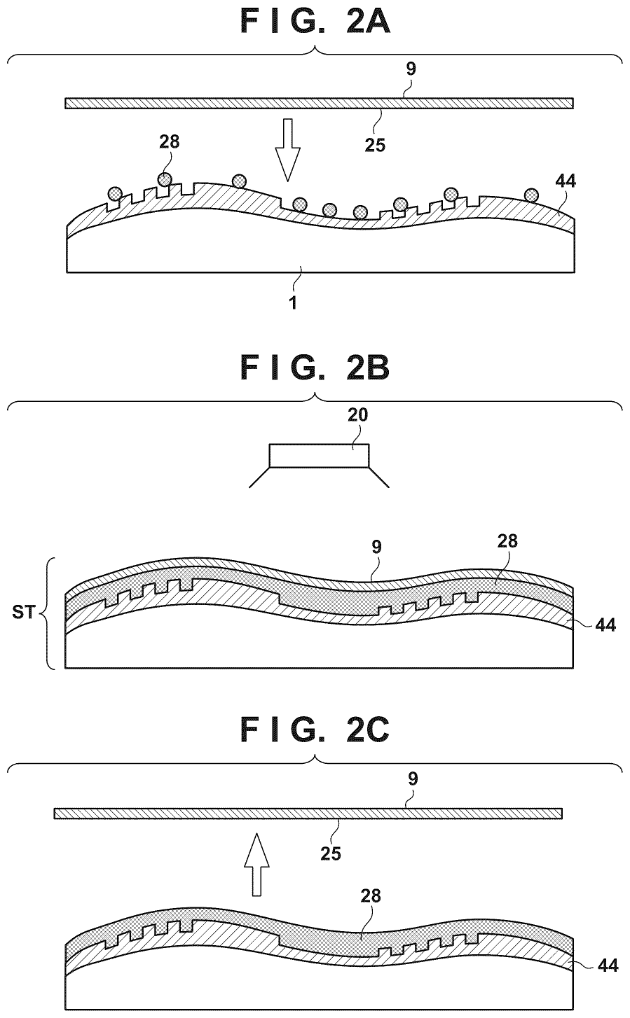

FIGS. 2A to 2C exemplarily show the procedure of a film forming method of forming a cured film by the cured product of a formable material on the substrate 1, more specifically, the procedure of a planarization method of forming a planarized film as the cured film. FIG. 2A schematically shows a state in which a formable material 28 is applied onto the substrate 1 including an underlying pattern 44, and the superstrate 9 is arranged to face the formable material 28. FIG. 2B schematically shows a state in which the superstrate 9 is brought into contact with the formable material 28 and a structure ST with the uncured formable material 28 sandwiched between the substrate 1 and the superstrate 9 is formed. In this state, a flat portion 25 of the superstrate 9 conforms to the macro shape of the surface of the underlying pattern 44 of the substrate 1. In the state shown in FIG. 2B, when a curing energy source 20 applies curing energy (for example, light having a longer wavelength than visible light) to the formable material 28 on the substrate 1, the formable material 28 is cured and a cured film is formed. Curing energy can be applied to the formable material 28 from the curing energy source 20 via the superstrate 9. Alternatively, the curing energy source 20 may be arranged on the back surface side of the substrate 1. Alternatively, the curing energy source 20 may heat the formable material 28 by heat transfer. Then, the superstrate 9 is separated from the cured film of the formable material 28. FIG. 2C schematically shows a state after the superstrate 9 is separated from the cured film of the formable material 28. Note that when a mold having a pattern is used instead of the superstrate 9, the cured film with the pattern transferred thereto can be obtained.

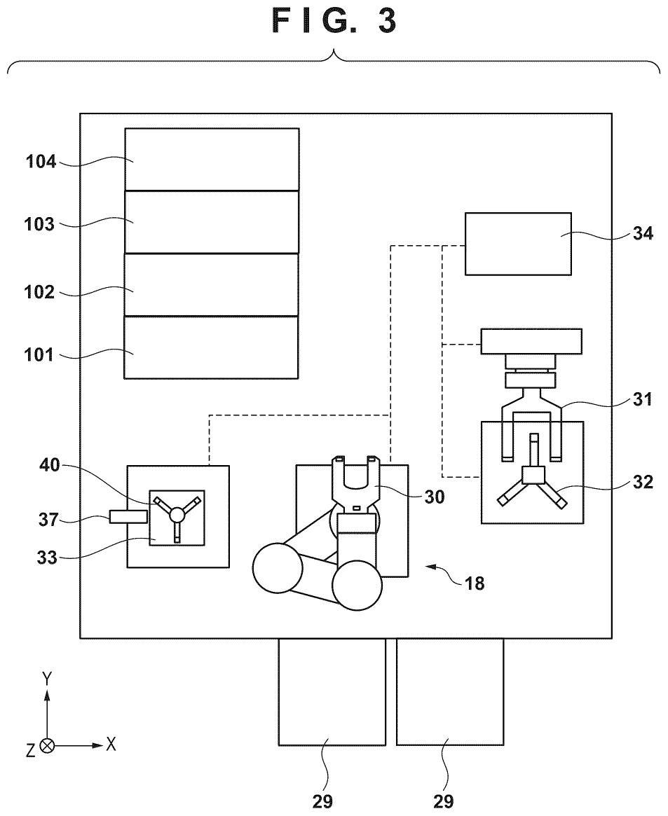

With reference to FIG. 3, conveyance of the superstrate 9, the substrate 1, and the structure ST will be described. The film forming apparatus 100 can include load ports 29 used to load the superstrate 9 and the substrate 1 from outside the film forming apparatus 100 and unload them to outside the film forming apparatus 100. The load port 29 can be used to load the substrate 1 in a carrier (not shown) into the film forming apparatus 100 and unload it from the film forming apparatus 100.

The conveyance mechanism 18 holds the substrate 1 in the carrier loaded into the load port 29 by a conveyance hand 30, and conveys the substrate 1 to an alignment apparatus 33. The alignment apparatus 33 performs alignment regarding the center position and rotation angle (orientation) of the substrate 1 so that the substrate 1 is conveyed to a predetermined position of the substrate chuck 2 on the substrate stage 3 at a predetermined rotation angle. The alignment apparatus 33 can include a driving stage (not shown), a substrate chuck 40, and a measurement device 37. The driving stage can include a driving mechanism for driving in the X-axis direction, the Y-axis direction, and the 0 direction (rotation around the Z-axis). The substrate chuck 40 can hold the substrate 1 by a holding pad or the like. Note that vacuum suction, suction-chucking, edge clamping, or the like can be used as the holding method. The alignment of the substrate 1 can be performed based on the center position and rotation angle (orientation) of the substrate 1 acquired by measuring the shape of the outer peripheral portion of the substrate by the measurement device 37 while rotating the substrate 1. The measurement device 37 can include, for example, an image capturing apparatus such as a CCD camera, and an arithmetic unit that processes an image to detect the position of an object on the image.

The conveyance mechanism 18 can hold, with the conveyance hand 30, the substrate 1 having undergone alignment by the alignment apparatus 33, and convey the substrate 1 to the substrate chuck 2 of the station 101 that executes the application process. The station 101 applies a formable material to the surface of the substrate 1. Then, the conveyance mechanism 18 can hold, with the conveyance hand 30, the substrate 1 in the station 101, and convey the substrate 1 to the substrate chuck 2 of the station 102 that executes the preparation process (and the separation process). The station 102 brings the superstrate 9 into contact with the formable material 28 on the substrate 1, thereby forming the structure ST as a stacked body of the substrate 1, the formable material 28, and the superstrate 9. When the superstrate 9 contacts the formable material 28, the formable material 28 starts to fill the space between the substrate 1 and the superstrate 9. When the structure ST formed by the preparation process is unloaded from the station 102, the station 102 can execute the preparation process for the next substrate 1 or execute the separation process for the structure ST having undergone the curing process. This can improve the throughput of the film forming process.

Thereafter, the conveyance mechanism 18 can hold, with the conveyance hand 30, the structure ST in the station 102, and convey the structure ST to the station 103 that executes the curing process. The station 103 waits until the space between the substrate 1 and the superstrate 9 is filled with the formable material 28. When the filling is completed, the station 103 applies curing energy to the formable material 28 of the structure ST by, for example, a heating plate 50 to cure the formable material 28. After this, the conveyance mechanism 18 can hold, with the conveyance hand 30, the structure ST in the station 103, and convey the structure ST to the station 104 that executes the cooling process. The station 104 can execute the cooling process of cooling the structure ST by a cooling plate 60.

Then, the conveyance mechanism 18 can hold, with the conveyance hand 30, the structure ST in the station 104, and convey the structure ST to the station 102 again that executes (the preparation process and) the separation process. Here, if a shift in the position in the X-axis direction or the Y-axis direction and/or the rotation angle of the structure ST occurs as a result of passing through the respective stations, the structure ST is preferably conveyed to the station 102 via the alignment apparatus 33. In the structure ST, the notch of the substrate 1 is hidden by the superstrate 9. Therefore, a camera preferably detects the notch from the back surface side (substrate 1 side) of the structure ST.

The station 102 executes the separation process of separating the superstrate 9 from the structure ST (the cured formable material 28 thereof). The conveyance mechanism 18 can hold, with the conveyance hand 30, the substrate 1 having undergone the separation process, and convey the substrate 1 to the carrier in the load port 29.

Next, conveyance of the superstrate 9 by the conveyance mechanism 18 will be described. The conveyance mechanism 18 can hold, with the conveyance hand 30, the superstrate 9 in a carrier loaded into the load port 29, and convey the superstrate 9 to an alignment apparatus 32. The alignment apparatus 32 can manipulate the superstrate 9 while clamping the edge of the superstrate 9 so as not to touch the flat portion of the superstrate 9. Similar to the substrate 1, the alignment apparatus 32 uses a camera (not shown) to align the center of the superstrate 9, and uses the mark of the superstrate 9 to align the rotation angle. The mark of the superstrate can be, for example, a SEMI T7 mark, a SEMI M12 mark, or a notch. The superstrate 9 having undergone the alignment can be reversed by a reversing apparatus 31. The conveyance hand 30 can reverse the superstrate 9 if the conveyance hand 30 includes a rotation mechanism.

The reversed superstrate 9 can be conveyed to the alignment apparatus 32 again. The reversed superstrate 9 can be held by a hand (not shown) that contacts only the edge of the superstrate 9, and conveyed to the mold chuck 11 of the station 102. Note that this hand may be provided in the conveyance mechanism 18. When collecting the superstrate 9, the hand (not shown) can receive the superstrate 9 from the mold chuck 11 and convey it to the reversing apparatus 31, and the superstrate 9 can be reversed by the reversing apparatus 31 and conveyed to the carrier in the load port 29.

A controller 34 controls operations of the load port 29, the conveyance mechanism 18, the reversing apparatus 31, the alignment apparatus 32, the alignment apparatus 33, and the stations 101 to 104.

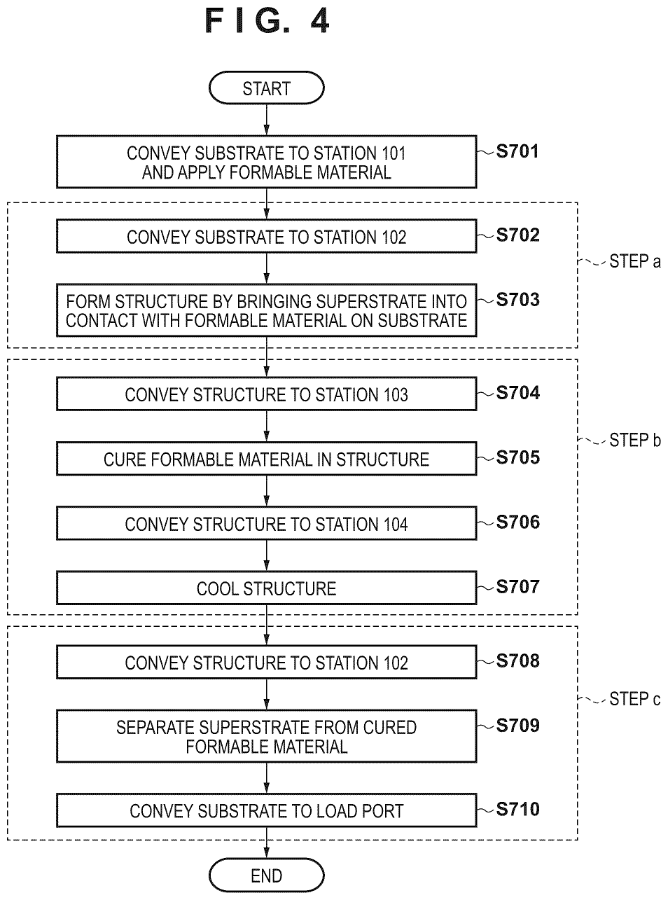

FIG. 4 shows the first embodiment of the operation of the film forming apparatus 100 or the film forming method. This operation is controlled by the controller 34. In step S701, the substrate 1 is conveyed to the substrate chuck 2 in the station 101, and the formable material 28 is applied onto the substrate 101 in the station 101. In step S702, the substrate 1 is conveyed from the station 101 to the station 102. In step S703, the station 102 executes a preparation process of bringing the superstrate 9 into contact with the formable material 28 on the substrate 1 to form the structure ST.

In step S704, the structure ST is conveyed from the station 102 to the station 103. In step S705, the station 103 executes a curing process of curing the formable material 28 by heating the formable material 28 of the structure ST by the heating plate 50. In step S706, the structure ST having undergone the curing process is conveyed from the station 103 to the station 104. In step S707, a cooling process of cooling the structure ST by the cooling plate 60 is executed. In step S708, the cooled structure ST is conveyed from the station 104 to the station 102. In step S709, a separation process of separating the superstrate 9 from the cured formable material 28 is executed. In step S710, the substrate 1 with the cured formable material 28, that is, a cured film or a planarized film formed thereon is unloaded to the load port 29.

According to the procedure described above, when heating the formable material 28, the formable material 28 is covered by the superstrate 9. If the formable material 28 is an organic material, when the formable material 28 is exposed to atmospheric oxygen, the formable material 28 can shrink in volume. However, with the procedure in which the formable material 28 is heated while being covered by the superstrate 9, volume shrinkage caused by oxygen can be suppressed, and a purge process for exhausting oxygen is unneeded. This is advantageous in terms of shortening the time required for the heating process and simplifying the apparatus arrangement.

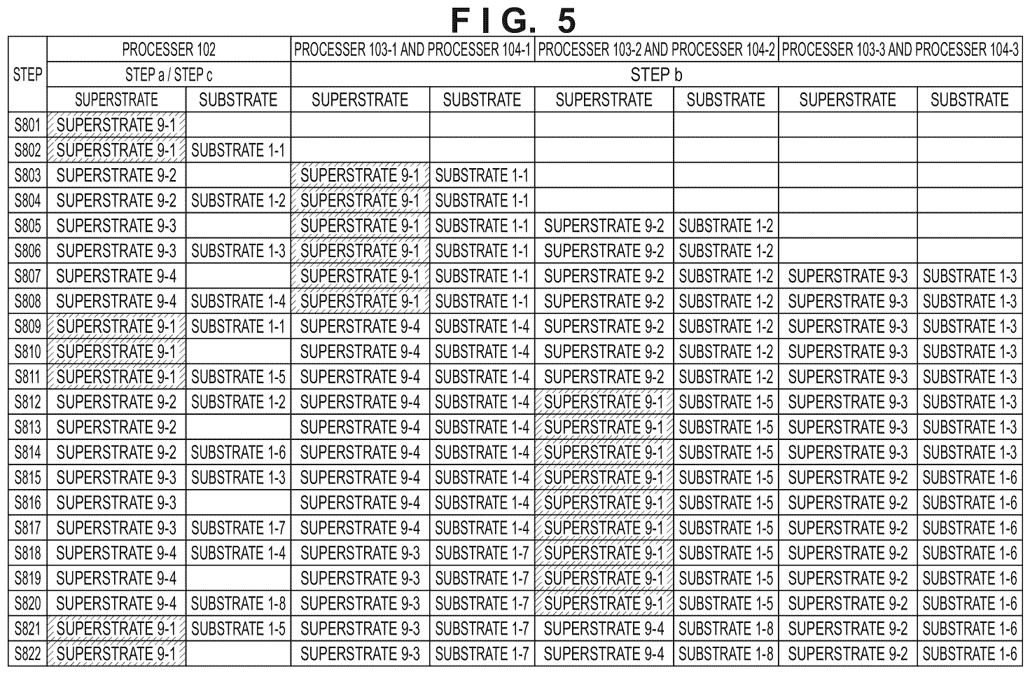

FIG. 5 shows the second embodiment of the operation of the film forming apparatus 100 or the film forming method. This operation is controlled by the controller 34. To fill the space between the substrate 1 and the superstrate 9 with the formable material 28 as described above, a long time can be required. In addition, the curing process in the station 103 can require a longer time than the processes in the station 101 and the station 102. Further, as the heating temperature for the curing process in the station 103 becomes higher, the longer time can be required for cooling the structure ST in the station 104. As a result, the processes in the stations 103 and 104 can be a bottleneck in improving the throughput of the film forming process.

To address this, in the second embodiment, a plurality of the stations 103 and a plurality of the stations 104 (three stations 103 and three stations 104 in the example shown in FIG. 5) are provided. Here, suffix numbers such as 1-1 and 1-2 are used to distinguish multiple substrates 1 from each another. Similarly, suffix numbers such as 9-1 and 9-2 are used to distinguish multiple superstrates 9 from each another. Step a in FIG. 5 corresponds to steps S702 and S703 shown in FIG. 4. Step b in FIG. 5 corresponds to steps S704 to S707 in FIG. 4. Step c in FIG. 5 corresponds to steps S708 to S710 in FIG. 4.

In step S801, a superstrate 9-1 is loaded into the station 102. In step S802, a substrate 1-1 with the formable material 28 applied thereto is loaded into the station 102, and the superstrate 9-1 is brought into contact with the formable material 28 to form the structure ST. In step S803, the structure ST formed from the substrate 1-1 and the superstrate 9-1 in step S802 is conveyed to stations 103-1 and 104-1 and processed in the procedure shown in FIG. 4 (steps S803 to S808).

In addition, in step S803, a next superstrate 9-2 is loaded into the station 102. In step S804, a next substrate 1-2 with the formable material 28 applied thereto is loaded into the station 102, and the superstrate 9-2 is brought into contact with the formable material 28 to form the structure ST. In step S805, the structure ST formed from the substrate 1-2 and the superstrate 9-2 in step S804 is conveyed to stations 103-2 and 104-2 and processed in the procedure shown in FIG. 4 (steps S805 to S811).

In addition, in step S805, a next superstrate 9-3 is loaded into the station 102. In step S806, a next substrate 1-3 with the formable material 28 applied thereto is loaded into the station 102, and the superstrate 9-3 is brought into contact with the formable material 28 to form the structure ST. In step S807, the structure ST formed from the substrate 1-3 and the superstrate 9-3 in step S806 is conveyed to stations 103-3 and 104-3 and processed in the procedure shown in FIG. 4 (steps S807 to S814).

In addition, in step S807, a next superstrate 9-4 is loaded into the station 102. In step S808, a next substrate 1-4 with the formable material 28 applied thereto is loaded into the station 102, and the superstrate 9-4 is brought into contact with the formable material 28 to form the structure ST. In step S809, the structure ST formed from the substrate 1-4 and the superstrate 9-4 in step S808 is exchanged with the structure ST (the substrate 1-1 and the superstrate 9-1) conveyed to the stations 103-1 and 104-1 in step S803. In the stations 103-1 and 104-1, the structure ST formed from the substrate 1-4 and the superstrate 9-4 is processed in the procedure shown in FIG. 4 (steps S809 to S817).

In step S810, in the station 102, the superstrate 9-1 is separated from the cured formable material on the substrate 1-1, and the substrate 1-1 is unloaded to the load port 29. In step S811, the superstate 9-1 separated from the cured formable material on the substrate 1-1 is reused. That is, a next substrate 1-5 is loaded into the station 102 and the superstrate 9-1 is brought into contact with the formable material 28 to form the structure ST. Subsequently, similar processes are repeated. In an example, the similar processes are continued up to a substrate 1-25. After substrate loading ends, the separated superstrates are subsequently stored in the load port 29 or a buffer station (not shown).

The operation or film forming method shown in FIG. 4 or 5 can form a part of an article manufacturing method for manufacturing an article. The article manufacturing method can include a film forming step of forming a film on a substrate by the operation or film forming method shown in FIG. 4 or 5, and a processing step of obtaining an article by processing the substrate having undergone the film forming step. The processing step can include, for example, a step of further forming a film, a step of forming a pattern, a step of performing etching using the pattern, and the like.

The film forming apparatus 100 exemplarily shown in FIG. 1 and the operation of the film forming apparatus 100 shown in FIG. 5 can have following aspects. Hereinafter, to distinguish the stations 102, 103, and 104 from each another, the station 102 is referred to as the first station, the station 103 is referred to as the second station, and the station 104 is referred to as the third station. Further, to distinguish multiple molds (as has been described above, the mold includes a mold with no pattern (superstrate) in addition to a mold with a pattern), they are referred to as the first mold, the second mold, and the third mold. To distinguish multiple substrates 1 from each other, they are referred to as the first substrate, the second substrate, the third substrate, and the fourth substrate. To distinguish multiple structures, they are referred to as the first structure, the second structure, and the third structure.

The first station 102 prepares the first structure by arranging the first mold (for example, 9-1) on the uncured formable material 28 on the first substrate (for example, 1-1) (for example, step S802), and then prepares the second structure by arranging the second mold (for example, 9-2) on the uncured formable material on the second substrate (for example, 1-2) (for example, step S804).

After preparing the second structure, the first station 102 holds the first mold (for example, 9-1) of the first structure conveyed to the first station 102 by the conveyance mechanism 18, and separates the first mold from the cured formable material 28 of the first structure (for example, step S810). The third station 104 further includes the third station that cools the structure having undergone the curing process in the second station 103, and the conveyance mechanism 18 conveys the structure from the third station 104 to the first station 102.

After separating the first mold (for example, 9-1) from the cured formable material 28 of the first structure, the first station 102 prepares the third structure by arranging the first mold (for example, 9-1) on the uncured formable material 28 on the third substrate (for example, 1-5) (for example, step S821).

After preparing the second structure, the first station 102 prepares the fourth structure by arranging the third mold (for example, 9-3) on the uncured formable material 28 on the fourth substrate (for example, substrate 1-7) before the first structure is conveyed to the first station 103 by the conveyance mechanism 18 (for example, step S817).

After executing the preparation process for the first substrate (for example, 1-1) (for example, step S802), the first station 102 executes the preparation process for at least one substrate (for example, 1-2 and 1-3) (for example, steps S804 and S806) before executing the separation process for the first substrate (for example, 1-1) (for example, step S810).

The film forming method includes a preparation step (for example, step S802) of preparing a structure with the uncured formable material 28 sandwiched between the substrate (for example, 1-1) and the mold (for example, 9-1) in the first station 102, a first conveyance step (for example, step S803) of conveying the structure from the first station 102 to the second station 103, a curing step (for example, steps S803 to S808) of curing the formable material 28 of the structure to form a cured film in the second station 103, a second conveyance step (for example, step S809) of conveying the structure having undergone the curing step to the first station 102, and a separation step (for example, step S810) of separating the mold (for example, 9-1) from the cured formable material 28 of the structure in the first station 102. The film forming method can further include a third conveyance step of conveying the structure having undergone the curing step from the second station 103 to the third station 104, and a cooling step of cooling the structure in the third station 104. In the second conveyance step, the structure having undergone the cooling step can be conveyed from the third station 104 to the first station 102.

The conveyance destination of the structure in the first conveyance step (for example, step S803) can be the second station (for example, 103-1) selected from a plurality of second stations.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-204129, filed Dec. 1, 2023, which is hereby incorporated by reference herein in its entirety.

What is claimed is:

1. A film forming apparatus comprising:
a first station configured to execute a preparation process of preparing a structure with an uncured formable material sandwiched between a substrate and a mold, and a separation process of separating the mold from the formable material of the structure after the formable material is cured;
one or a plurality of second stations configured to execute a curing process of forming a cured film by curing the formable material of the structure; and
a conveyance mechanism configured to convey the structure between a plurality of stations including the first station and the second station.

2. The apparatus according to claim 1, wherein
after preparing a first structure by arranging a first mold on an uncured formable material on a first substrate, the first station prepares a second structure by arranging a second mold on an uncured formable material on a second substrate.

3. The apparatus according to claim 2, wherein
after preparing the second structure, the first station holds the first mold of the first structure conveyed to the first station by the conveyance mechanism, and separates the first mold from the cured formable material of the first structure.

4. The apparatus according to claim 3, further comprising a third station configured to cool the structure having undergone the curing process in the second station,
wherein the conveyance mechanism conveys the structure from the third station to the first station.

5. The apparatus according to claim 3, wherein
after separating the first mold from the formable material of the first structure, the first station prepares a third structure by arranging the first mold on an uncured formable material on a third substrate.

6. The apparatus according to claim 3, wherein
after preparing the second structure, the first station prepares a fourth structure by arranging a third mold on an uncured formable material on a fourth substrate before the first structure is conveyed to the first station by the conveyance mechanism.

7. The apparatus according to claim 2, wherein
after executing the preparation process for the first substrate, the first station executes the preparation process for at least one substrate before executing the separation process for the first substrate.

8. The apparatus according to claim 1, wherein
in the second station, the formable material is cured by heat.

9. The apparatus according to claim 1, wherein
in the second station, the formable material is cured by light.

10. The apparatus according to claim 1, wherein
the apparatus is configured to form a cured film having a planarized surface by using a mold having a flat surface as the mold.

11. The apparatus according to claim 1, wherein
the apparatus is configured to form a cured film with a pattern transferred thereto by using a mold having a surface formed with the pattern as the mold.

12. A film forming method comprising:
preparing a structure with an uncured formable material sandwiched between a substrate and a mold in a first station;
conveying the structure from the first station to a second station;
curing the formable material of the structure to form a cured film in the second station;
conveying the structure having undergone the curing to the first station; and
separating the mold from the cured formable material of the structure in the first station.

13. The method according to claim 12, further comprising:
conveying the structure having undergone the curing from the second station to a third station; and
cooling the structure in the third station,
wherein in the conveying the structure having undergone the curing to the first station, the structure having undergone the cooling is conveyed from the third station to the first station.

14. The method according to claim 12, wherein
a conveyance destination of the structure in the conveying the structure from the first station is a second station selected from a plurality of second stations.

15. The method according to claim 12, wherein
after the preparing is executed for a plurality of substrates, the separating is executed for the plurality of substrates.

16. The method according to claim 12, wherein
in the curing, the formable material is cured by heat.

17. The method according to claim 12, wherein
the mold is a mold having a flat surface.

18. The method according to claim 17, wherein
the mold is a mold made of silicon.

19. The method according to claim 17, wherein
the mold is a mold made of one of glass, quartz, and PMMA.

20. The method according to claim 12, wherein
in the curing, the formable material is cured by light.

21. The method according to claim 20, wherein
the mold is a mold having a surface with a pattern formed therein.

22. An article manufacturing method comprising:
forming a film on a substrate by a film forming method defined in claim 12; and
obtaining an article by processing the substrate having undergone the forming.
